(19) United States
(12) Patent Application Publication
(10) Pub. No.: US 2003/0127571 A1
(43) Pub. Date: Jul. 10, 2003

(54) Support column for reel of film or similar for rotating platform winding apparatus

(76) Inventor: Antonio Marchetti, Milano (IT)

Correspondence Address: JACOBSON HOLMAN PLLC, 400 SEVENTH STREET N.W., SUITE 600, WASHINGTON, DC, 20004, US

(21) Appl. No.: 10/337,326

(22) Filed: Jan. 7, 2003

(30) Foreign Application Priority Data
Jan. 7, 2002 (IT) MI2002U 000003

(51) Int. Cl. F16L 3/00

(52) U.S. Cl. 248/121

(57) ABSTRACT

The present invention refers to a support column for reel of film or similar for rotating platform winding apparatus. The column comprises a vertical upright and a support base for said upright. The upright is made up of two C-shaped section bars positioned with opposed cavities and fastened to each other by fastening means applied during the mounting phase, in particular by nailing or riveting. Basin-shaped transversal stiffening plates are positioned and similarly fastened at preset heights of the upright. Along a back wall of one of the two section bars a vertical sliding guide for a reel-holder trolley is positioned and similarly fastened.

The present invention refers to a support column for reel of film or similar for rotating platform winding apparatus.

For winding film or similar tape around an article or group of articles piled on a pallet or other suitable support, winding equipments that are made up of a motorized rotating platform and of a support column for a reel of windable film that rises and descends along the column are generally utilized.

In the known equipments of that type the support column of the reel is made up of a plurality of parts welded together. This creates evident operating and storing problems.

The object of the present invention is to produce a column for supporting the reel for the rotating platform winding apparatus that entails less operating and storing problems.

In accordance with the invention said object is achieved with a support column, comprising a vertical upright and a base supporting said upright, characterized in that said upright is made up of two C-shaped section bars positioned with opposed cavities and fastened to each other by fastening means applied during the mounting phase, in particular by nailing or riveting.

In addition basin-shaped transversal stiffening plates are positioned and similarly fastened at preset heights of the upright.

Finally a vertical sliding guide for a reel holder trolley is positioned and similarly fastened along the back wall of one of the two section bars.

It is evident that to make the column in parts that can be stored separately and fastened to each other during the mounting phase by nailing or riveting considerably simplifies the operations to be carried out and leads to considerable saving of space in the warehouse.

The characteristics of the present invention will appear evident from the following detailed description of an embodiment thereof represented in the enclosed drawing wherein:

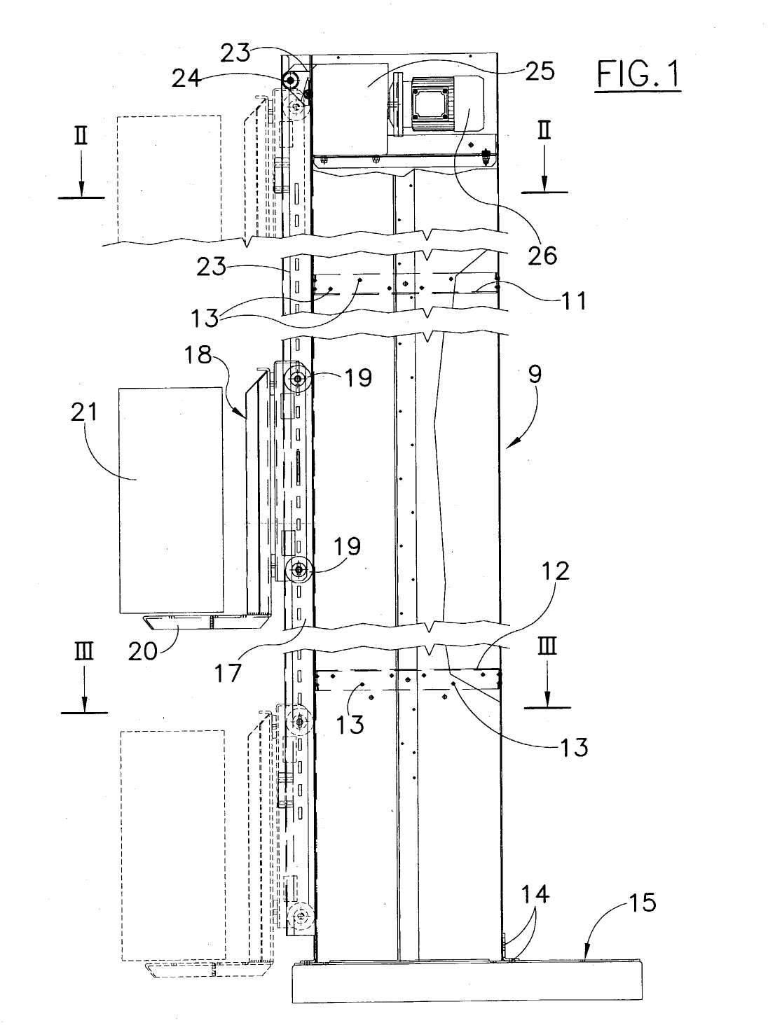

FIG. 1 shows a first elevation view of a support column of the reel in accordance with the present invention;

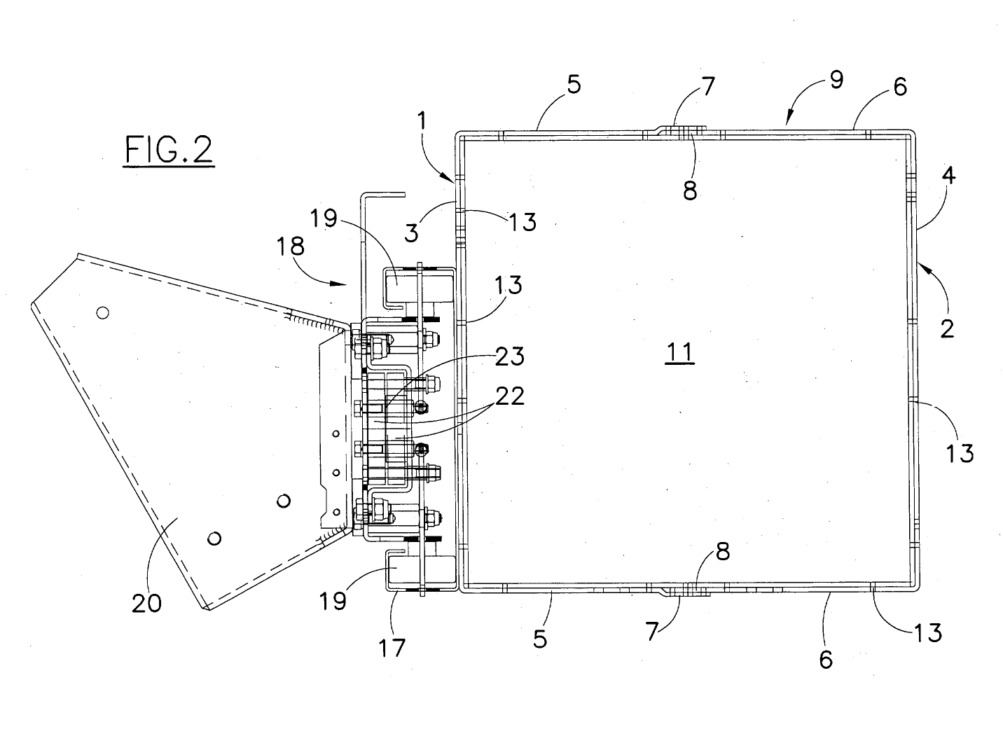

FIG. 2 shows the above mentioned column in transversal section according to the line II-II of FIG. 1;

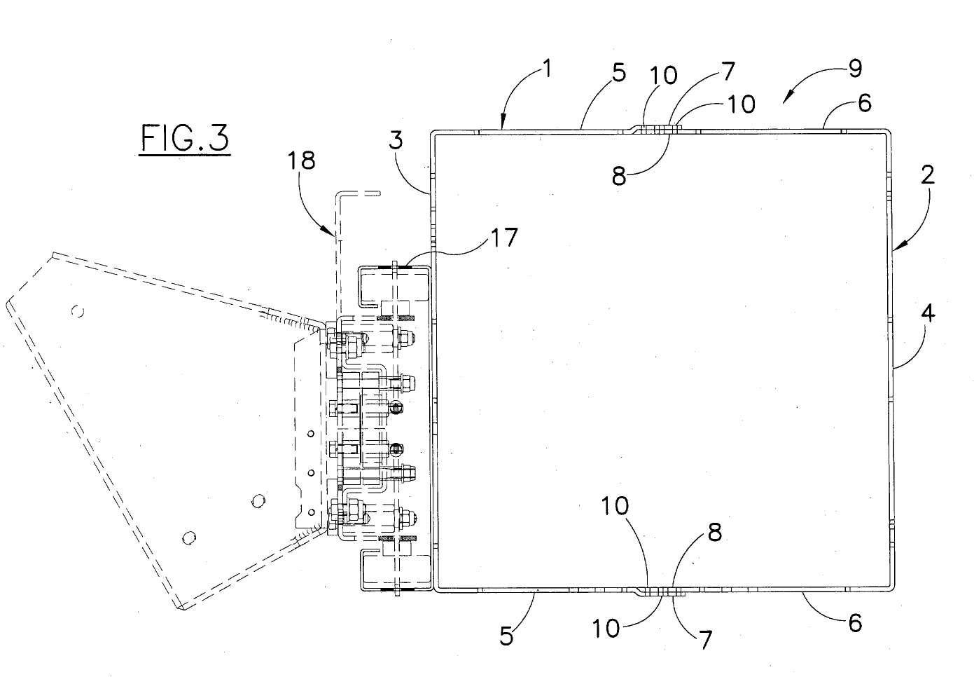

FIG. 3 shows the above mentioned column in transversal section according to the line III-III of FIG. 1;

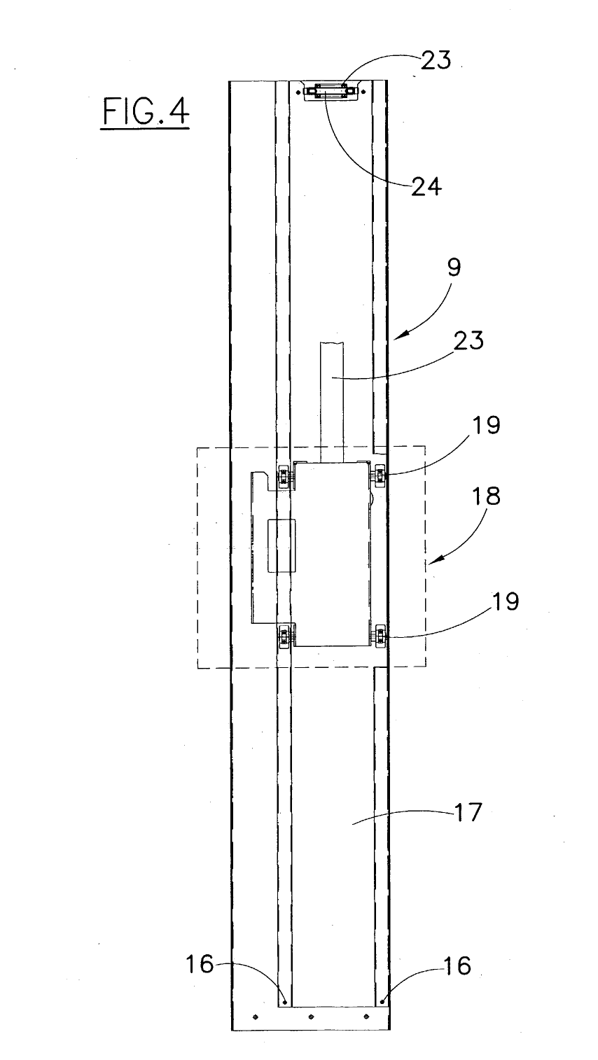

FIG. 4 shows a second elevation view, from the left in relation to FIG. 1, of the same support column.

The support column shown in the drawings is made up of two section bars 1 and 2 with C section at right angles, each of which, as shown in FIGS. 2 and 3, is made up of a back wall 3, 4 and of two side walls 5, 6 of reduced extension. The side walls 5 of the section bar 1 have ends 7 widened outwards.

The two section bars 1 and 2 are mounted with opposed cavities and with the above-mentioned ends 7 of the section bar 1 overlaying the corresponding ends 8, coplanar with the remaining wall parts of the side walls 6 of the section bar 2. This results in a box-shaped upright 9 with a substantially square section.

The mutual fastening of the two section bars is carried out by nailing or riveting in correspondence with holes 10.

Two squared transversal stiffening plates 11 and 12 are inserted and fastened by nailing or riveting, at intermediate heights between the base and the top of the two section bars, both with edges folded at 90° to constitute a sort of basin, which are positioned one with the cavity upwards and the other with the cavity downwards. The fastening of the plates is carried out by nailing or riveting in holes 13.

The box-shaped upright 9 thus formed is placed over and fastened onto, again by bolting in holes 14, a box-shaped base 15 (with the possibility of rotation) represented schematically in FIG. 1.

As shown in FIGS. 1 and 4, a vertical sliding guide 17 for a trolley 18 with wheels 19 which carries a support base 20 for a reel 21 of windable tape, in particular for a reel of film, is positioned along the back wall 3 of the section bar 1 and fastened, again by nailing or riveting in holes 16.

The trolley 18, whose details have been omitted for the sake of simplicity in FIG. 4, is suspended by means of anchoring means 22, only schematically illustrated in FIGS. 2 and 3, to a hoisting belt 23, which at the top of the upright 9 is deviated by a pulley 24 inside a winding-unwinding mechanism 25 activated by a motor 26 (FIG. 1).

1. Support column for reel of film or similar for rotating platform winding apparatus, comprising a vertical upright and a support base for said upright, characterized in that said upright is made up of two C-shaped section bars positioned with opposed cavities and fastened to each other by fastening means applied during the mounting phase, in particular by nailing or riveting.

2. Support column according to claim 1, characterized in that said section bars has a back wall and two side walls perpendicular to the back wall, with ends partially overlaying and fastened to each other.

3. Support column according to claim 1 or 2, characterized in that at preset heights of the upright basin-shaped transversal stiffening plates are positioned and similarly fastened.

4. Support column according to claim 2, characterized in that a vertical sliding guide for a reel-holder trolley is positioned and similarly fastened along the back wall of one of the two section bars.
